(19) United States
(12) Patent Application Publication
(10) Pub. No.: US 2008/0247522 A1
(43) Pub. Date: Oct. 9, 2008

(54) PRIVATE BRANCH EXCHANGE, TELEPHONE TERMINAL, AND TELEPHONE SYSTEM HAVING THE PRIVATE BRANCH EXCHANGE AND THE TELEPHONE TERMINAL

(75) Inventor: Yuuichi OKUYA, Kanagawa (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/061,138

(22) Filed: Apr. 2, 2008

(30) Foreign Application Priority Data
Apr. 6, 2007 (JP) 2007-100908

(51) Int. Cl. H04M 11/00

(52) U.S. Cl. 379/93.01

(57) ABSTRACT

A PBX transmits a superimposed signal to telephones via internal lines, the signal being generated from a transmission data signal modulated and converted into an analog form and a transmission voice signal. The PBX also receives a superimposed signal from the telephones via the internal lines, the signal being generated from a reception data signal and a reception voice signal. The PBX then retrieves the reception data signal and the reception voice signal separately, and digitally converts and modulates the reception data signal. The telephones also have similar functions as those of the PBX and communicate with the PBX via the internal lines.

### CROSS-REFERENCE TO RELATED APPLICATIONS

The present application claims priority under 35 U.S.C. §119 of Japanese Application No. 2007-100908, filed on Apr. 6, 2007, the disclosure of which is expressly incorporated by reference herein in its entirety.

### BACKGROUND OF THE INVENTION

1. Field of the Invention

The present invention relates to a private branch exchange, a telephone terminal, and a telephone system having the private branch exchange and the telephone terminal.

2. Description of Related Art

Conventionally, when a data communication system having a plurality of data communication apparatuses is introduced to a home, an office, or a factory provided with a telephone system, it is a general practice to build a network with lines separate from internal lines (private telephone lines) to which a plurality of telephones are connected for the telephone system. For example, in a system configured with a gateway apparatus (connected to both external and internal lines), a PBX (Private branch eXchange; connected to the gateway apparatus), a plurality of internal telephones (connected to the PBX), and a plurality of PCs (Personal Computers; connected to the gateway apparatus), each internal telephone is connected to the PBX through internal lines while each PC is connected to the gateway apparatus through a LAN cable (refer to Related Art 1).

[Related Art 1] Japanese Patent Laid-open Publication 2006-166385

In the conventional technology as disclosed in Related Art 1, however, when a PC is to be connected to a network, a separate LAN cable for data communication needs to be wired even though internal lines for a telephone system are already installed. Therefore, problems such as shortage of wiring space and increase of wiring cost arise. In such a case, a network may be built using an already existing power line instead of a LAN cable. However, since the power line is not originally intended for data communication, it is likely to generate noise and variation of impedance due to other electric devices connected to the power line. Therefore, the transmission characteristics can be inferior to a situation where a separate communication line such as a LAN cable is used.

### SUMMARY OF THE INVENTION

The present invention is provided to address the above-described conventional problems. A main purpose of the present invention is to provide a private branch exchange, a telephone terminal, and a telephone system having the private branch exchange and the telephone terminal, that enable data communication utilizing internal telephone lines installed in a private network, and build a network for the data communication without new wiring.

The private branch exchange that is connected to a public telephone network, a data communication network and an internal line, the internal line connecting to a telephone terminal. The private branch exchange includes: a modulator that modulates a first digital data signal and that outputs a first modulated digital data signal; an analog converter that converts the first modulated digital data signal into a first analog data signal; a transmitter that superimposes the first analog data signal on a first sound data signal and that transmits a first superimposed signal to the telephone terminal via the internal line, the first sound data signal being received from the public telephone network; a receiver that receives a second superimposed signal from the telephone terminal via the internal line and that extracts a second analog data signal from the second superimposed signal; a digital converter that converts the second analog data signal into a second modulated digital data signal; and a demodulator that demodulates the second modulated digital data signal and that outputs a second digital data signal.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a schematic configuration of a telephone system according to a present embodiment;

FIG. 2 is a block diagram illustrating a configuration of a PBX;

FIG. 3 is a block diagram illustrating a configuration of a telephone line connection unit;

FIG. 4 is a block diagram illustrating a configuration of a telephone line communication control circuit shown in FIG. 3;

FIG. 5 is a block diagram illustrating a configuration of a telephone connected to an internal line; and

FIG. 6 is a block diagram illustrating a configuration of a telephone line communication control circuit shown in FIG. 5.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

According to an embodiment of the present invention, a private branch exchange is provided in a private network, connected to a public telephone network for voice communication and a data communication network for data communication, and connected to a telephone via an internal line installed in the private network. The private branch exchange includes: a modulator that modulates a digital transmission data signal; an analog converter that converts the digital transmission data signal modulated by the modulator into an analog signal; a transmitter that transmits a superimposed signal to the telephone via the internal line, the superimposed signal being generated from the analog transmission data signal converted by the analog converter and a transmission voice signal; a data signal retriever that retrieves an analog reception data signal from an superimposed signal generated from the analog reception data signal and reception voice signal, the superimposed signal being received from the telephone via the internal line; a digital converter that converts the analog reception data signal retrieved by the data signal retriever into a digital signal; a demodulator that demodulates the digital reception data signal converted by the digital converter; and a voice signal retriever that retrieves the reception voice signal from the superimposed signal received from the telephone via the internal line.

In addition, a telephone is provided in a private network and connected to a private branch exchange via an internal line installed in the private network. The telephone includes: an input unit that inputs a transmission voice signal; a modulator that modulates a digital transmission data signal; an analog converter that converts the digital transmission data signal modulated by the modulator into an analog signal; a transmitter that transmits a superimposed signal to the private branch exchange via the internal line, the superimposed signal being generated from the analog transmission data signal converted by the analog converter and the transmission voice signal being input by the input unit; a data signal retriever that retrieves an analog reception data signal from an superimposed signal generated from the analog reception data signal and reception voice signal, the superimposed signal being received from the private branch exchange via the internal line; a digital converter that converts the analog reception data signal retrieved by the data signal retriever into a digital signal; a demodulator that demodulates the digital reception data signal converted by the digital converter; and a voice signal retriever that retrieves the reception voice signal from the superimposed signal received from the private branch exchange via the internal line.

Accordingly, a superimposed signal is transmitted to telephones via internal lines, the signal being generated from a transmission data signal modulated and converted into an analog form and a transmission voice signal. A superimposed signal is also received from the telephones via the internal lines, the signal being generated from a reception data signal and a reception voice signal. The reception data signal and the reception voice signal are separately retrieved, in order to digitally convert and modulate the reception data signal. Therefore, it is possible to have a beneficial effect of realizing data communication that utilizes telephone internal lines installed in a private network and building a data communication network that does not require new wiring.

An embodiment of the present invention is illustrated below with reference to the drawings.

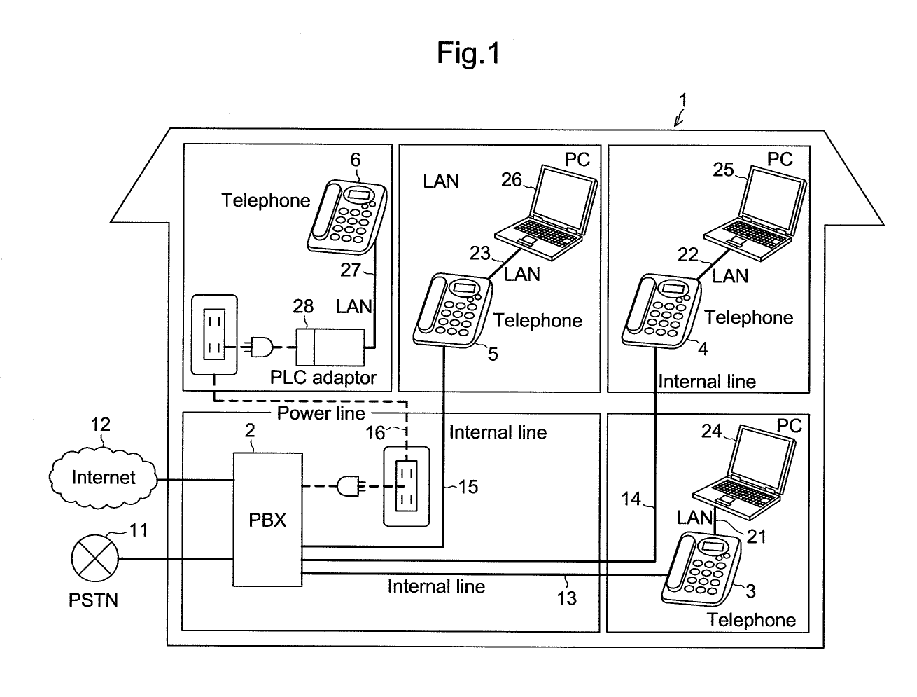

FIG. 1 illustrates a schematic configuration of a telephone system according to the embodiment. Telephone system 1 mainly includes PBX 2 and a plurality of telephones 3-6 each connected to PBX 2. In this example, the schematic configuration is provided in which PBX 2 and telephones 3-6 are each located in one of 5 rooms in a house.

PBX 2 is a private branch exchange that employs a digital method, and, in this example, is connected to PSTN (Public Switched Telephone Network) 11 mainly for voice communication and Internet (data communication network) 12 mainly for data communication. The connection between PBX 2 and telephones 3-5 is realized through internal lines 13-15, which are phone lines provided inside a household. The connection between PBX 2 and telephone 6 is realized through power line 16 provided inside the household.

The private branch exchange according to the present embodiment is not limited to one like PBX 2, but may be a simplified exchange such as a business telephone and a home telephone having similar functions.

Telephones 3-5 are multifunction telephones that employ a digital method and have functions such as transfer and internal line communication functions. Telephones 3-5 perform voice communication among themselves and with an external telephone (not shown) connected to PSTN 11 via PBX 2. Telephones 3-5 can also work as relays between PBX 2 and PC 24-26, which are respectively connected to telephones 3-5 via LAN cables 21-23.

When telephones 3-5 perform voice communication, information signals related to the communicated voice (hereinafter referred to as communication voice signals) are exchanged with PBX 2 via respective internal lines 13-15. When telephones 3-5 work as relays, information signals related to the data communication (hereinafter referred to as data signals) are superimposed with the communication voice signals transmitted on internal lines 13-15 to generate composite signals (hereinafter referred to as superimposed signals), which are exchanged with PBX 2. Accordingly, it is possible for PCs 24-26 to perform data communication by utilizing internal lines 13-15, which are used by telephones 3-5 for voice communication, thereby eliminating the need to newly wire a network built for the data communication for PCs 24-26.

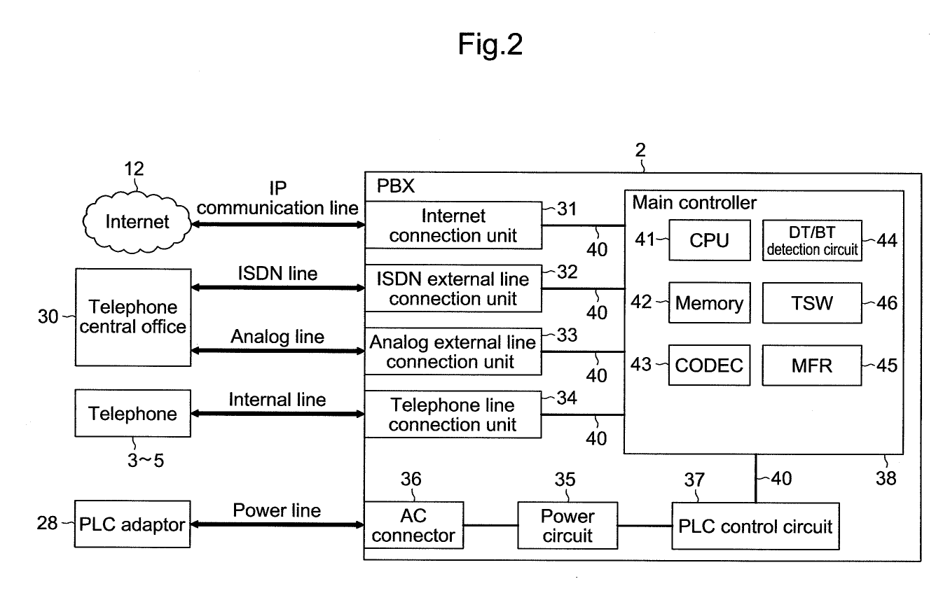

Telephone 6 is an IP (Internet Protocol) multifunction telephone that has similar functions to those of telephones 3-5, such as transfer and internal voice communication functions, and exchanges voice data based on the VoIP (Voice over Internet Protocol). The communication between telephone 6 and PBX 2 is performed by PLC (Power Line Communications) adaptor 28 and PLC control circuit 37 (refer to FIG. 2) that superimpose information signals at relatively high frequencies (e.g., 4 MHz-28 MHz) with power signals (e.g., 60 Hz) transmitted on power line 16, and mutually perform communication. PLC adaptor 28 is connected through LAN cable 27 and the PLC control circuit 37 is installed in PBX 2 having similar functions to the PLC adaptor 28.

PCs 24-26 are equipped with a network communication function and perform data communication with other apparatuses via LAN cables 21-23, according to a protocol such as TCP/IP. In this embodiment, telephones 3-5 are enabled to work as relays, so that PCs 24-26 can perform data communication with each other or with other external PCs (not shown) connected to the Internet 12 via PBX 2.

The apparatus to perform data communication via telephones 3-5 is not limited to a PC, but may be another information processing apparatus having similar communication functions. Or, telephones 3-5 themselves may be configured to have the data communication functions similar to those of PCs 24-26. In addition, PLC adaptor 28 may be connected not only to telephone 6, but also a PC or the like that perform data communication. This would make it possible for the PCs in the private network to perform data communication by utilizing the power line network and telephone internal lines, thereby increasing flexibility when building the network.

FIG. 2 is a block diagram illustrating a configuration of the PBX shown in FIG. 1. PBX 2 includes Internet connection unit 31, ISDN external line connection unit 32, analog external line connection unit 33, telephone line connection unit 34, PLC control circuit 37, and main controller 38. Internet connection unit 31 is connected to an IP communication line and performs data communication with an external PC and the like on Internet 12. ISDN external line connection unit 32 is connected to an ISDN (Integrated Services Digital Network) line and performs voice communication with an external telephone (not shown) via telephone central office 30 or data communication with an external PC and the like. Analog external line connection unit 33 is connected to an analog line and performs voice communication with an external telephone via telephone central office 30. Telephone line connection unit 34 is connected to an internal line and performs voice communication or data communication with telephones 3-5. PLC control circuit 37 is connected to a power line via power circuit 35 and AC connector 36 and performs communication via the power line. Main controller 38 controls overall operation of each unit of PBX 2, and performs a line exchange process for voice and data communications among the apparatuses within the private network (telephones 3-6 and PCs 24-26) or between an apparatus within the private network and an apparatus outside the network (external telephone, PC, etc.).

Main controller 38 is connected to each connection unit 31-34 and PLC control circuit 37 via bus 40. Main controller 38 includes CPU 41, memory 42, CODEC 43, DT/BT detection circuit 44, MFR 45, and time switch (TSW) 46. CPU 41 controls the line exchange process related to the voice and data communications performed by PBX 2, according to a predetermined control program. Memory 42 provides a work area for the control performed by CPU 41. CODEC 43 performs mutual conversion between digital and analog voices, and encoding and decoding. DT/BT detection circuit 44 detects a dial tone (DT) and busy tone (BT) during voice communication. MFR 45 performs detection and the like of a PB (push button) signal. Time switch (TSW) 46 performs an exchange control.

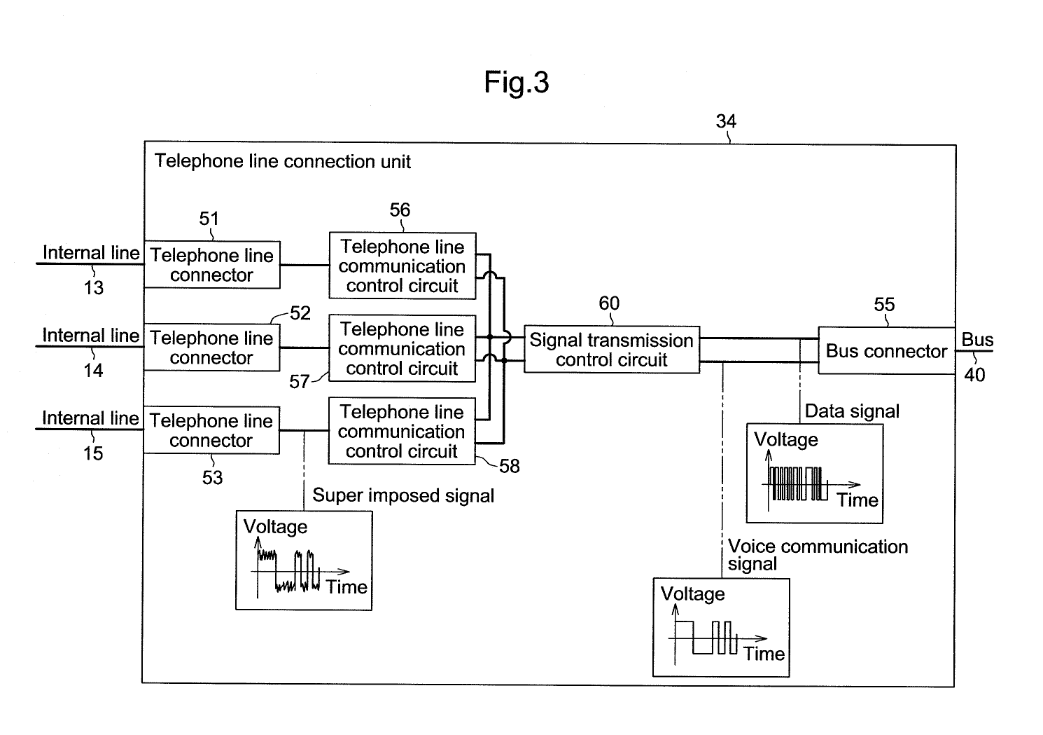

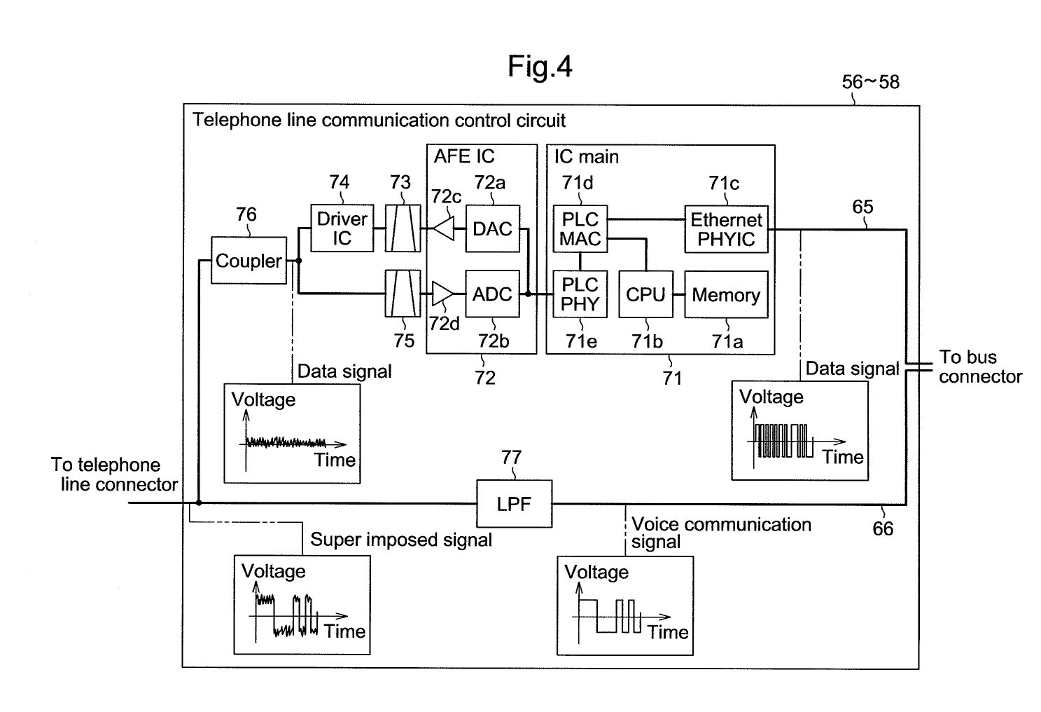

FIG. 3 is a block diagram illustrating a configuration of the telephone line connection unit shown in FIG. 2. Between blocks, transmitted signals (communication voice signals, data signals and their superimposed signals) and their waveform images are respectively shown (also in FIGS. 4-6). Telephone line connection unit 34 has telephone line connectors 51-53, bus connector 55, telephone line communication control circuits 56-58, and signal transmission control circuit 60. Telephone line connectors 51-53 are respectively connected to internal lines 13-15 from telephones. Bus connector 55 is connected to bus 40 from the main controller. Telephone line communication control circuits 56-58 control voice and data communications with telephones via internal lines 13-15. Signal transmission control circuit 60 manages transmission of communication voice signals and data signals on lines between bus connector 55 and each of telephone line connectors 51-53.

Telephone line connectors 51-53 are 6P2C or 6P4C modular connectors (e.g., RJ-11), to which corresponding connectors attached to one ends of internal lines 13-15 (configured with modular cables) are connected.

In telephone line connection unit 34 having the above-described configuration, the digital communication voice signals and data signals to be transmitted to a telephone from PBX 2 (signals related to voice and data communications with an external apparatus, a telephone within the private network, or a PC) are each input via a mutually distinct line from bus connector 55. The input signals are transmitted to telephone line communication control circuits 56-58 on the transmission path from signal transmission control circuit 60, each circuit 56-58 being provided on the transmission path to which a counterpart telephone or a PC is connected. Then, telephone line communication control circuits 56-58 superimpose analog data signals (e.g., signals in a bandwidth of 3 kHz-30 MHz) converted through a DA conversion from the digital data signals, with communication voice signals. Then, the superimposed signals are transmitted to internal lines 13-15. On the other hand, similarly superimposed signals are transmitted from the telephones directed to PBX 2, and input from telephone line connectors 51-53. The superimposed signals are separated into data signals and communication voice signals by telephone line communication control circuits 56-58, and are separately transmitted to bus connector 55.

FIG. 4 is a block diagram illustrating a configuration of the telephone line communication control circuit shown in FIG. 3. Telephone line communication control circuits 56-58 have transmission paths 65 and 66, the former transmitting data signals between the telephone line connector side and the bus connector side, the latter transmitting communication voice signals. Transmission paths 65 and 66 join at the telephone line connector side. On transmission path 65, IC main 71, AFE/IC 72, coupler 76 and the like are provided. IC main 71 performs a signal processing such as modulation, demodulation, and the like of digital data signals. AFE/IC 72 performs AD and DA conversions of data signals. Coupler 76 enables two-way transmission of the data signals between the bus connector side and the telephone line connector side. A portion of transmission path 65 branches into a transmission side path and a reception side path. IC main 71 includes memory 71a, CPU (Central Processing Unit) 71b, Ethernet PHY/IC 71c, PLC/MAC (Power Line Communication/Media Access Control layer) block 71d that manages a MAC layer, and PLC/PHY (Power Line Communication/Physical layer) block 71e that manages a PHY layer. The transmission side of AFE/IC 72 is provided with DA converter 72a that converts digital signals into analog signals, and variable amplifier 72c that amplifies the analog signals. The reception side of AFE/IC 72 is provided with AD converter 72b that converts analog signals into digital signals, and variable amplifier 72d that amplifies signals. Further, the transmission side path has low pass filter 73 and driver IC 74, while the reception side path has band pass filter 75. Coupler 76 includes a combined transformer or photo coupler, and has filter characteristics that filter the superimposed signals to stop the communication voice signals from the telephone line connector side and to pass the data signals having relatively high frequencies. On the other hand, transmission path 66 has a low pass filter 77 that filters the superimposed signals to stop the data signals having relatively high frequencies and to pass the communication voice signals.

In telephone line communication control circuits 56-58 having the above-described configuration, digital data signals input from the bus connector side are first modulated by IC main 71. Then, the modulated digital modulation data is converted into analog signals by DA converter 72a of AFE/IC 72, and amplified by variable amplifier 72c. The analog signals converted from the digital signals and amplified are further passed through low pass filter 73, driver IC 74, and coupler 76. On the other hand, the communication voice signals input from the bus connector side are passed through low pass filter 77. The analog data signals passed through coupler 76 are superimposed on the communication voice signals passed through low pass filter 77 at the telephone line connector side, and the superimposed signals are transmitted to the telephone line connector.

Conversely, the superimposed signals input from the telephone line connector are transmitted into both transmission paths 65 and 66. The superimposed signals transmitted into transmission path 65 are first filtered by coupler 76 to stop the communication voice signals so that only the data signals are retrieved. The retrieved data signals are passed through band pass filter 75, amplified by variable amplifier 72d, and converted into digital signals by AD converter 72b. The digitally converted data signals are demodulated by IC main 71 and transmitted to the bus connector side. On the other hand, the superimposed signals transmitted into transmission path 66 are filtered by low pass filter 77 to stop the data signals and to only retrieve the communication voice signals, which are then transmitted to the bus connector side.

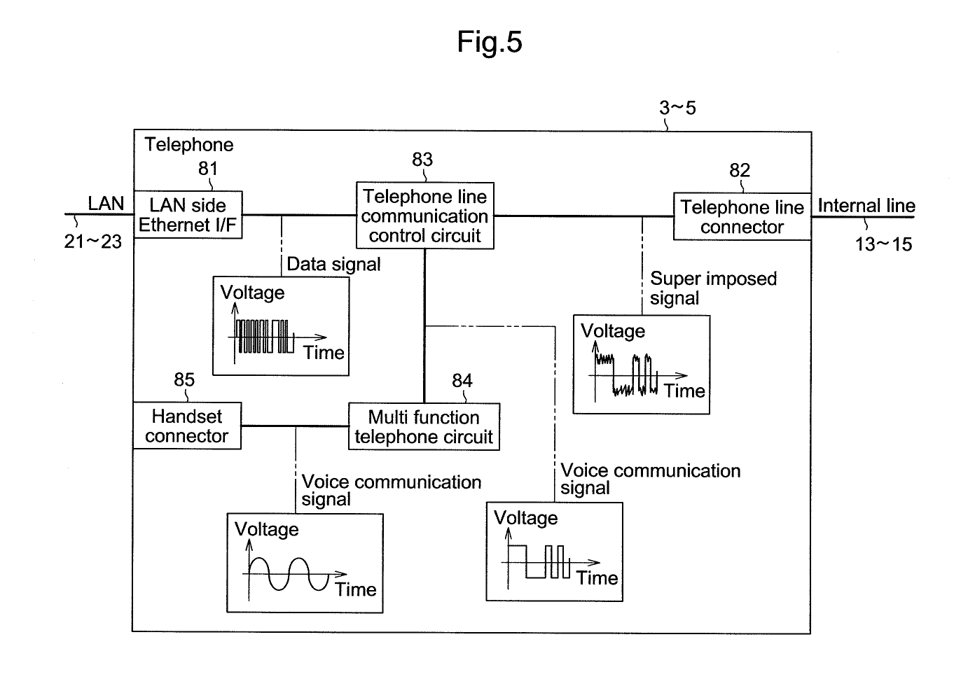

FIG. 5 is a block diagram illustrating a configuration of a telephone that is connected to the internal line shown in FIG. 1. Each of telephones 3-5 includes LAN side Ethernet I/F (interface) 81, telephone line connector 82, telephone line communication control circuit 83, multifunction telephone circuit 84, and handset connector 85. LAN side Ethernet I/F 81 is connected to one of LAN cables 21-23 from PCs. Telephone line connector 82 is connected to one of internal lines 13-15 from the PBX. Telephone line communication control circuit 83 connects Ethernet I/F 81 and telephone line connector 82, and controls voice and data communications with PBX 2 via one of internal lines 13-15. Multifunction telephone circuit 84 detects control signals from the PBX, and performs processing such as A/D and D/A conversions of communication voice signals. Handset connector 85 is connected to a handset (not shown).

Ethernet I/F 81 is an 8P8C modular connector (e.g., RJ-45) and is connected to a corresponding connector to which one end of one of LAN cables 21-23 is attached.

In telephones 3-5 having the above-described configuration, digital data signals input from Ethernet I/F 81 (i.e., signals related to data communication of a PC) are input to telephone line communication control circuit 83. Then, telephone line communication control circuit 83 superimposes analog data signals, converted from the digital data signals, on communication voice signals from the handset side, and transmits the superimposed signals to one of internal lines 13-15. On the other hand, superimposed signals input from telephone line connector 82 are separated into data signals and communication voice signals by telephone line communication control circuit 83, and transmitted to one of LAN cables 21-23 and handset connector 85 respectively.

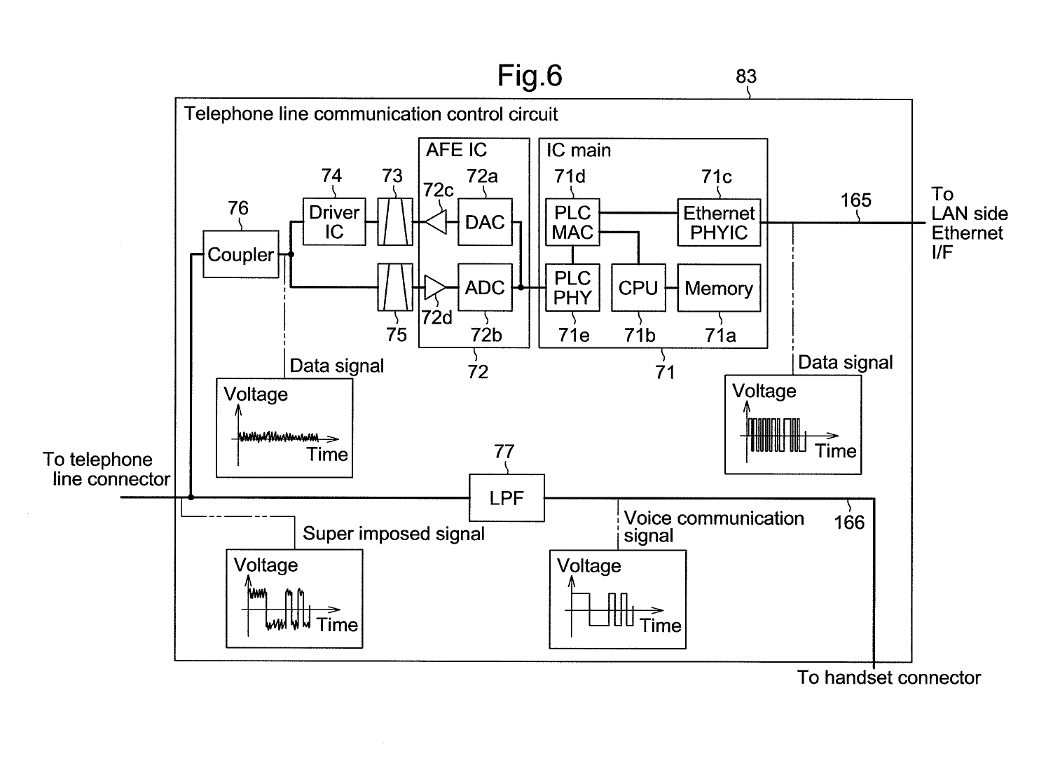

FIG. 6 is a block diagram illustrating a configuration of the telephone line communication control circuit shown in FIG. 5. Telephone line communication control circuit 83 has transmission paths 165 and 166, the transmission path 165 transmitting data signals between the telephone line connector side and the Ethernet I/F side, the transmission path 166 transmitting communication voice signals between the telephone line connector side and the handset connector side. Telephone line communication control circuit 83 has generally similar functions to telephone line communication control circuits 56-58 shown in FIG. 4. The same configuration elements as telephone line communication control circuits 56-58 shown in FIG. 4 are given the same numerical references and their detailed illustrations are therefore omitted.

In telephone line communication control circuits 83 having the above-described configuration, the digital data signals input from the Ethernet I/F side are first modulated by IC main 71. Then, the modulated digital modulation data signals are converted into analog signals by DA converter 72a of AFE/IC 72, and amplified by variable amplifier 72c. The analog data signals converted from the digital signals and amplified are further passed through low pass filter 73, driver IC 74, and coupler 76. On the other hand, the communication voice signals input from the handset connector side are passed through low pass filter 77. The analog data signals passed through coupler 76 are superimposed on the communication voice signals passed through low pass filter 77 at the telephone line connector side, and the superimposed signals are transmitted to the telephone line connector.

Conversely, the superimposed signals input from the telephone line connector are transmitted into both transmission paths 165 and 166. The superimposed signals transmitted into transmission path 165 are first filtered by coupler 76 to stop the communication voice signals so that only the data signals are retrieved. The retrieved data signals are passed through band pass filter 75, amplified by variable amplifier 72d, and converted into digital signals by AD converter 72b. The digitally converted data signals are demodulated by IC main 71 and transmitted to the Ethernet I/F side. On the other hand, the superimposed signals transmitted into transmission path 166 are filtered by low pass filter 77 to stop the data signals and to only retrieve the communication voice signals, which are then transmitted to the handset connector side.

The private branch exchange, the telephone, and the telephone system having the private branch exchange and the telephone according to the present invention enable data communication utilizing internal telephone lines installed in the private network, and a network to be built for the data communication without new wiring. Therefore, the present invention can be effectively applied to a private branch exchange, a telephone and a telephone system having the private branch and the telephone.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A private branch exchange that is connected to a public telephone network, a data communication network and an internal line, the internal line connecting to a telephone terminal, the private branch exchange comprising:
a modulator that modulates a first digital data signal and that outputs a first modulated digital data signal;
an analog converter that converts the first modulated digital data signal into a first analog data signal;
a transmitter that superimposes the first analog data signal on a first sound data signal and that transmits a first superimposed signal to the telephone terminal via the internal line, the first sound data signal being received from the public telephone network;
a receiver that receives a second superimposed signal from the telephone terminal via the internal line and that extracts a second analog data signal from the second superimposed signal;
a digital converter that converts the second analog data signal into a second modulated digital data signal; and
a demodulator that demodulates the second modulated digital data signal and that outputs a second digital data signal.

2. The private branch exchange according to claim 1, wherein the receiver extracts a second sound data signal from the second superimposed signal, the second sound data signal being output to the public telephone network.

3. The private branch exchange according to claim 1 further comprising a power line communication controller, the second digital data signal being output to a power line via the power line controller.

4. A telephone terminal that is connected to a private branch exchange via an internal line and to a data communication network, the telephone terminal comprising:
a connector configured to input an input sound data signal;
a modulator that modulates a third digital data signal and that outputs a third modulated digital data signal;
an analog converter that converts the third modulated digital data signal into a third analog data signal;
a transmitter that superimposes the third analog data signal on the input sound data signal and that transmits a third superimposed signal to the private branch exchange via the internal line;
a receiver that receives a fourth superimposed signal from the private branch exchange via the internal line and that extracts a fourth analog data signal from the fourth superimposed signal;
a digital converter that converts the fourth analog data signal into a fourth modulated digital signal; and
a demodulator that demodulates the fourth modulated digital data signal and that outputs a fourth digital data signal.

5. The telephone terminal according to claim 4, wherein the receiver extracts an output sound data signal from the fourth superimposed signal, the output sound data signal being output via the connector.

6. A telephone system comprising a private branch exchange and a telephone terminal, the private branch exchange being connected to a public telephone network, a data communication network and a internal line, the telephone terminal being connected to the internal line,
wherein the private branch exchange comprises:
a first modulator that modulates a first digital data signal and that outputs a first modulated digital data signal;
a first analog converter that converts the first modulated digital data signal into a first analog data signal;
a first transmitter that superimposes the first analog data signal on a first sound data signal and that transmits a first superimposed signal to the telephone terminal via the internal line, the first sound data signal being received from the public telephone network;
a first receiver that receives a second superimposed signal from the telephone terminal via the internal line and that extracts a second analog data signal from the second superimposed signal;
a first digital converter that converts the second analog data signal into a second modulated digital data signal; and
a first demodulator that demodulates the second modulated digital data signal and that outputs a second digital data signal, and
wherein the telephone terminal:
a connector configured to input an input sound data signal;
a second modulator that modulates a third digital data signal and that outputs a third modulated digital data signal;
a second analog converter that converts the third modulated digital data signal into a third analog data signal;
a second transmitter that superimposes the third analog data signal on the input sound data signal and that transmits a third superimposed signal to the private branch exchange via the internal line;
a second receiver that receives a fourth superimposed signal from the private branch exchange via the internal line and that extracts a fourth analog data signal from the fourth superimposed signal;
a second digital converter that converts the fourth analog data signal into a fourth modulated digital signal; and
a second demodulator that demodulates the fourth modulated digital data signal and that outputs a fourth digital data signal.
